(19) United States
(12) Patent Application Publication
(10) Pub. No.: US 2012/0147132 A1
(43) Pub. Date: Jun. 14, 2012

(54) Method and System for Producing Panoramic Image

(75) Inventors: Wen-Chao Chen, Kaohsiung City (TW); Chung-Wei Lin, Tainan City (TW); Tien-You Lee, Hsinchu City (TW)

(73) Assignee: Industrial Technology Research Institute, Hsinchu (TW)

(21) Appl. No.: 13/160,253

(22) Filed: Jun. 14, 2011

(30) Foreign Application Priority Data
Dec. 10, 2010 (TW) 99143316

(51) Int. Cl. H04N 5/225; G06K 9/36

(52) U.S. Cl. 348/36; 382/284; 348/E05.024

(57) ABSTRACT

A method and a system for producing a panoramic image are provided. The method comprises the following steps. A plurality of original images are obtained. A plurality of pixel blocks corresponding to a plurality of view angles are captured from each of the original images, wherein the number of the view angles is larger than or equal to 2. Part of the pixel blocks which are corresponding to one of the view angles are connected along a connecting direction to result in a single-view panoramic image, wherein the step of connecting part of the pixel blocks are performed repeatedly to result in a plurality of single-view panoramic images.

This application claims the benefit of Taiwan application Serial No. 099143316, filed Dec. 10, 2010, the subject matter of which is incorporated herein by reference.

### BACKGROUND

1. Technical Field

The disclosure relates to a method and a system for producing a panoramic image.

2. Description of the Related Art

Recently, the image display technology progresses largely, a stereoscopic image and a panoramic image are presented to the public. As the stereoscopic image and the panoramic image are popular applied in varied products, the quality thereof is needed to be improved. The image display technology progresses toward high resolution, big size and compatibility for varied user platform, and the stereoscopic image and the panoramic image display technology as well. For reaching the target described above, it is needed to set up a complex equipment system with heavy cost.

Generally, in a conventional process making an image having multi-view stereoscopic vision, several cameras need to be shot at the same time. Furthermore, in a conventional process making an image having super resolution, the image having super resolution is built via software and therefore the quality is not good enough. Moreover, in a conventional process making an image having panoramic vision, the image having panoramic vision is built via software also, and therefore the complexity is extremely high.

### SUMMARY

The disclosure is directed to a method and a system for producing a panoramic image.

According to a first aspect of the present disclosure, a method for producing a panoramic image is provided. The method comprises the following steps. A plurality of original images are obtained. A plurality of pixel blocks corresponding to a plurality of view angles are captured from each of the original images, wherein the number of the view angles is larger than or equal to 2. Part of the pixel blocks which are corresponding to one of the view angles are connected along a connecting direction to result in a single-view panoramic image, wherein the step of connecting part of the pixel blocks are performed repeatedly to result in a plurality of single-view panoramic images.

According to a second aspect of the present disclosure, a method for producing a panoramic image is provided. The method comprises the following steps. A plurality of original images which are continuously captured along a plurality of moving paths located on a sphere are obtained by a shooting unit. A plurality of pixel blocks corresponding to a view angle are captured from each of the original images. Part of the pixel blocks which are corresponding to one of the moving paths are connected along a first connecting direction to result in a single-view panoramic image, wherein the step of connecting part of the pixel blocks are performed repeatedly to result in a plurality of single-view panoramic images. All of the single-view panoramic images which are corresponding to all of the moving paths are connected along a second connecting direction which is substantially perpendicular to the first connecting direction to result in a super-resolution single-view panoramic image.

According to a third aspect of the present disclosure, a system for producing a panoramic image is provided. The system comprises a shooting unit, a multi-axles stand, a pixel capturing unit, a first connecting unit, a second connecting unit and an interlacing unit. The multi-axles stand is for moving the shooting unit along a plurality of moving paths located on a sphere. The shooting unit continuously captures a plurality of original images while the shooting unit is moving. The pixel capturing unit is for capturing a plurality of pixel blocks corresponding to a plurality of view angles from each of the original images. The number of the view angles is larger than or equal to 2. The first connecting unit is for connecting part of the pixel blocks which are corresponding to one of the moving paths and corresponding to one of the view angles along a first connecting direction to result in a single-view panoramic image. The first connecting unit repeatedly connects some of the pixel blocks to result a plurality of single-view panoramic images. The second connecting unit is for connecting part of the single-view panoramic images which are corresponding to all of the moving paths and corresponding to one of the view angles along a second connecting direction which is substantially perpendicular to the first connecting direction to result in a super-resolution single-view panoramic image. The second connecting unit repeatedly connects part of the single-view panoramic images to result in a plurality of super-resolution single-view panoramic images. The interlacing unit is for interlacing all of the super-resolution single-view panoramic images which are corresponding to all of the view angles to result in a super-resolution multi-view panoramic image.

The disclosure will become apparent from the following detailed description of the preferred but non-limiting embodiments. The following description is made with reference to the accompanying drawings.

### BRIEF DESCRIPTION OF THE DRAWINGS

FIG. 1 is a schematic illustration showing a system for producing a panoramic image of a first embodiment;

FIG. 2 is a flow chart showing a method for producing the panoramic image of the first embodiment;

FIG. 3 is a schematic illustration showing the step S101 in FIG. 2;

FIG. 4 is a schematic illustration showing view angles;

FIG. 5 is a flow chart showing the step S103 in FIG. 2;

FIG. 6 is a flow chart showing the step S105 in FIG. 2;

FIG. 7 is a flow chart showing the step S107 in FIG. 2;

FIG. 8 is a flow chart showing the step S111 in FIG. 2;

FIG. 9 is a schematic illustration showing a system for producing a panoramic image of a second embodiment;

FIG. 10 is a flow chart showing a method for producing the panoramic image of the second embodiment;

FIG. 11 is a schematic illustration showing a system for producing a panoramic image of a third embodiment; and

FIG. 12 is a flow chart showing a method for producing the panoramic image of the third embodiment.

### DETAILED DESCRIPTION

### First Embodiment

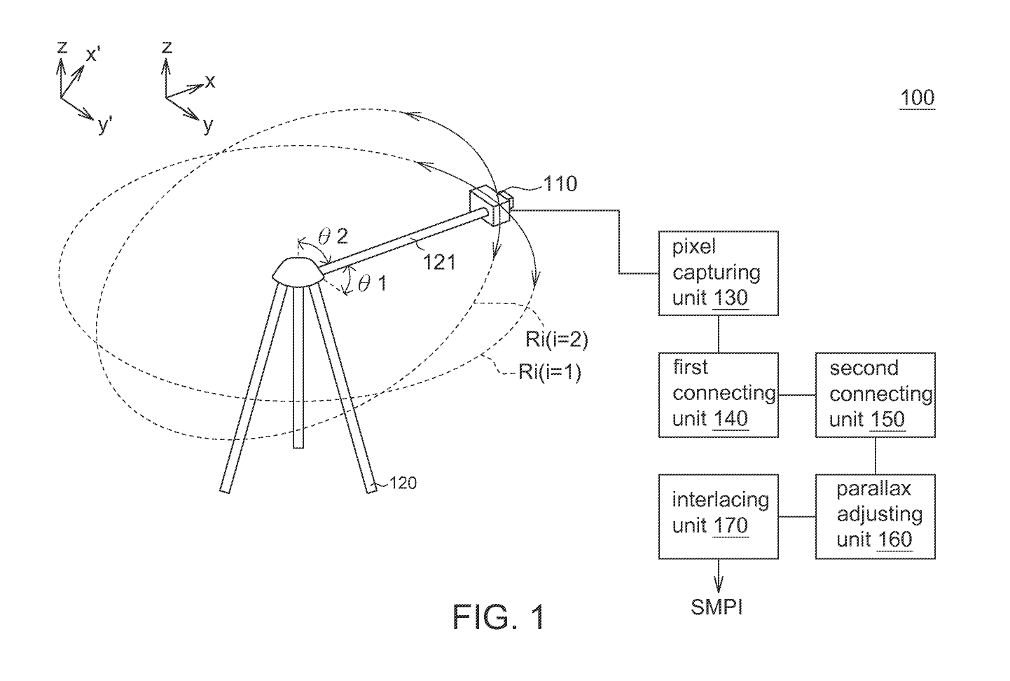

Please refer to FIG. 1. FIG. 1 is a schematic illustration showing a system 100 for producing a panoramic image of the first embodiment. The system 100 includes a shooting unit 110, a multi-axles stand 120, a pixel capturing unit 130, a first connecting unit 140, a second connecting unit 150, a parallax adjusting unit 160 and an interlacing unit 170. The shooting unit 110 is used for shooting an image. For example, the shooting unit 110 can be a camera having a single lens set, a video camera having a single lens set or a portable electric device having camera function. The multi-axles stand 120 is used for loading the shooting unit 110 and rotating the shooting unit 110 around multi-axles. The pixel capturing unit 130 is used for capturing a plurality of pixel blocks from an image. The first and second connecting units 140, 150 are used for connecting the pixel blocks or images to result in a big image. The parallax adjusting unit 160 is used for adjusting the parallax of an image to be within the stereo fusion range of human eyes. The interlacing unit 170 is used for interlacing the pixel blocks from different images to result in a stereoscopic image. The pixel capturing unit 130, the first connecting unit 140, the second connecting unit 150, the parallax adjusting unit 160 and the interlacing unit 170 can be realized via a microprocessor chip, a firmware or a storage medium having a plurality of codes.

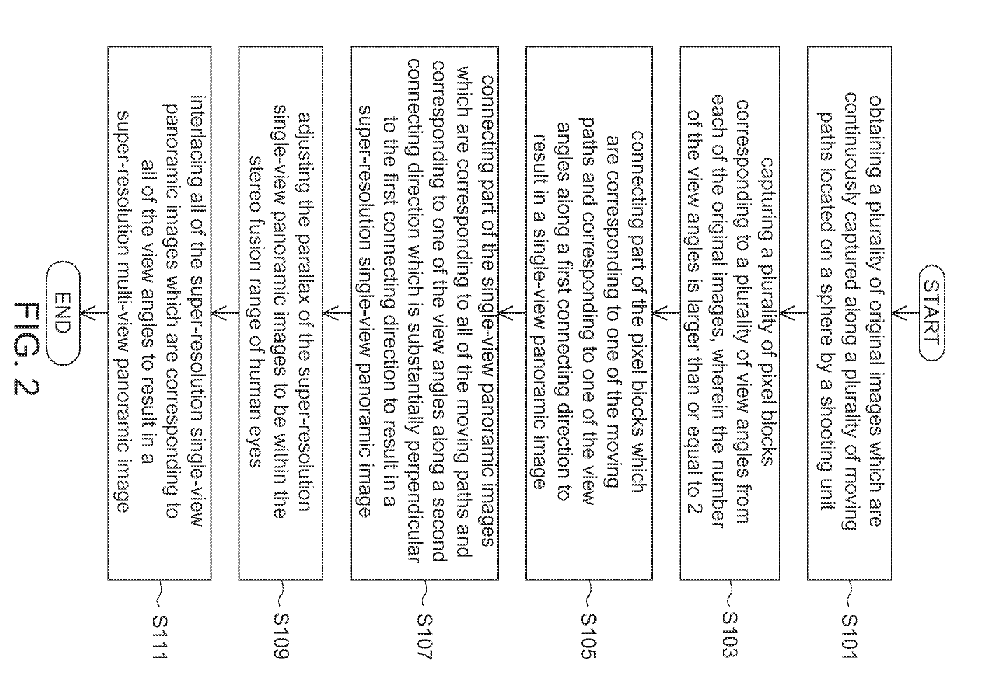

Please refer to FIG. 2. FIG. 2 is a flow chart showing a method for producing the panoramic image of the first embodiment. The operation of the system 100 is illustrated with the flow chart. However, a person of ordinary skill in the art would know that the system 100 for producing the panoramic image of the present disclosure is not limited to the flow chart of FIG. 2, and the method for producing the panoramic image of the present disclosure is not limited to the system 100 of FIG. 1.

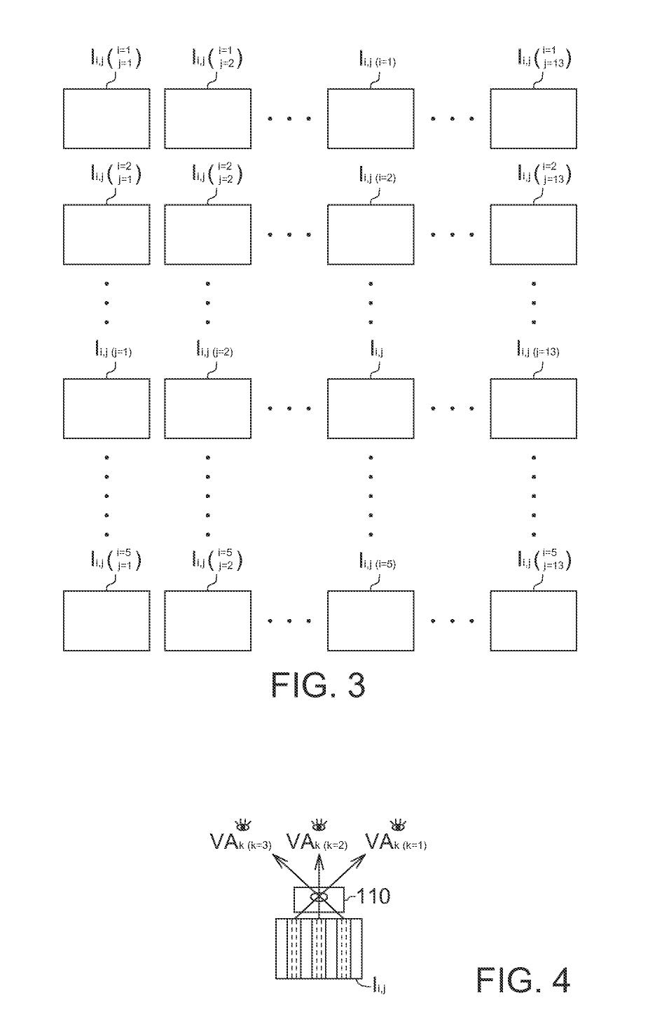

Please refer to FIG. 3. FIG. 3 is a schematic illustration showing the step S101 in FIG. 2. In the step S101, a plurality of original images I_{i,j} are obtained by the shooting unit 110. In the present embodiment, the suffix “i” of each original image I_{i,j} is a positive integer ranging from 1 to 5 and the suffix “j” of each original image I_{i,j} is a positive integer ranging from 1 to 13. In other embodiment, the suffix “i” of each original image I_{i,j} can be any positive integer and suffix “j” of each original image I_{i,j} can be any positive integer. Please referring to FIG. 1, the original images I_{i,j} are continuously captured along a plurality of moving paths Rᵢ by the shooting unit 110. In the present embodiment, the suffix “i” of each moving path Rᵢ is a positive integer ranging from 1 to 5. The moving paths Rᵢ are located on a sphere. The original image I_{i,j} is captured on the moving path Rᵢ at order j.

For example, please referring to FIG. 1, the shooting unit 110 is loaded on one end of a shaft 121 of the multi-axles stand 120. The multi-axles stand 120 changes a horizontal angle θ1 gradually by rotating on a X-Y plane around another end of the shaft 121, such that the shooting unit 110 moves along one of the moving paths Rᵢ (i=1 to 5), such as Rᵢ (i=1). While the shaft 121 rotates on the same plane and the horizontal angle θ1 is changed in the same interval, the shooting unit 110 will shoot the original images I_{i,j} (i=1 to 5, j=1 to 13), such as I_{i,j} (i=1, j=1) to I_{i,j} (i=1, j=13), at several shooting place spaced at equal intervals.

In addition, a vertical angle θ2 of the shaft 121 of the multi-axles stand 120 can be changed also, such that the shaft 121 can be changed to X′-Y′ plane. And then the multi-axles stand 120 changes the vertical angle θ2 gradually by rotating on the X′-Y′ plane around another end of the shaft 121, such that the shooting unit 110 moves along another one of the moving paths Rᵢ (i=1 to 5), such as Rᵢ (i=2).

For example, please referring to FIG. 3, the shooting unit 110 moves along five moving paths Rᵢ (i=1 to 5), and shoots 13 original images I_{i,j} (i=1 to 5, j=1 to 13), such as I_{i,j} (j=1) to I_{i,j} (j=13), on each of the moving paths Rᵢ (i=1 to 5). Thus, 65 (=5×13) piece of original images I_{i,j} (i=1 to 5, j=1 to 13) will be captured by the shooting unit 110.

Please refer to FIG. 4. FIG. 4 is a schematic illustration showing view angles VAₖ. In one of the original images I_{i,j} (i=1 to 5, j=1 to 13), different pixel blocks are corresponding different view angles VAₖ. In the present embodiment, the suffix “k” of each view angle VAₖ is a positive integer ranging from 1 to 3. In other embodiment, the suffix “k” of each view angle VAₖ can be a positive integer which is larger than or equal to 2.

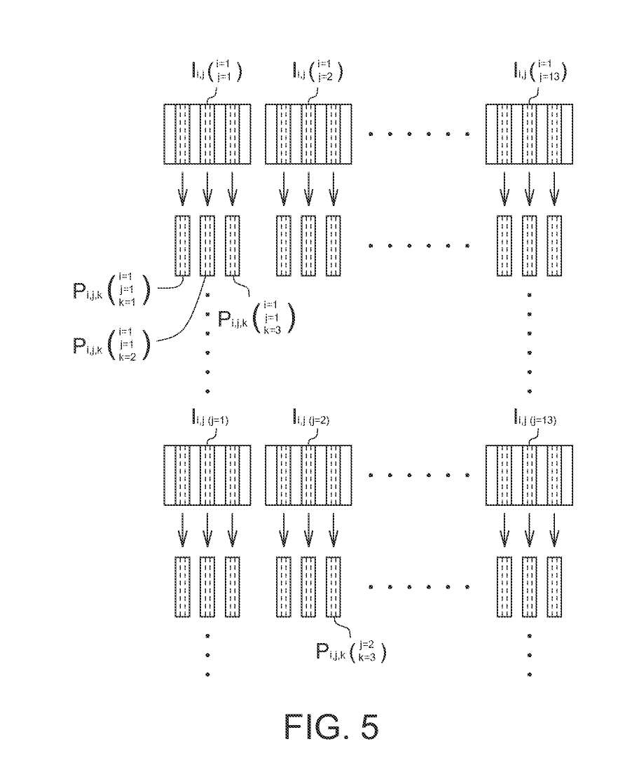

In the step S103, please refer to FIG. 5. FIG. 5 is a flow chart showing the step S103 in FIG. 2. The pixel capturing unit 130 captures a plurality of pixel blocks P_{i,j,k} (i=1 to 5, j=1 to 13, k=1 to 3), such as P_{i,j,k} (k=1), corresponding to one of the view angles VAₖ (k=1 to 3), such as VAₖ (k=1), from each of the original images I_{i,j} (i=1 to 5, j=1 to 13). Each of the pixel blocks P_{i,j,k} (i=1 to 5, j=1 to 13, k=1 to 3) includes a plurality of columns of pixels, such as three columns of pixels.

Then, the pixel capturing unit 130 captures another set of pixel blocks P_{i,j,k} (i=1 to 5, j=1 to 13, k=1 to 3), such as P_{i,j,k} (k=2), corresponding to another one of the view angles VAₖ (k=1 to 3), such as VAₖ (k=2), from each of the original images I_{i,j} (i=1 to 5, j=1 to 13). Repeatedly, the pixel capturing unit 130 can capture the pixel blocks P_{i,j,k} (i=1 to 5, j=1 to 13, k=1 to 3) corresponding to different view angles VAₖ (k=1 to 3) from all of the original images I_{i,j} (i=1 to 5, j=1 to 13).

For example, please referring to FIG. 5, the pixel blocks P_{i,j,k} (i=1 to 5, j=1 to 13, k=1 to 3) corresponding to different view angles VAₖ (k=1 to 3) are captured form each of the original image I_{i,j} (i=1 to 5, j=1 to 13). In the present embodiment, the number of the original images I_{i,j} (i=1 to 5, j=1 to 13) is 65 and the number of the view angles VAₖ (k=1 to 3) is 3, thus the number of the pixel blocks P_{i,j,k} (i=1 to 5, j=1 to 13, k=1 to 3) is 65. Each of the pixel blocks P_{i,j,k} (i=1 to 5, j=1 to 13, k=1 to 3) consists of three columns of pixels.

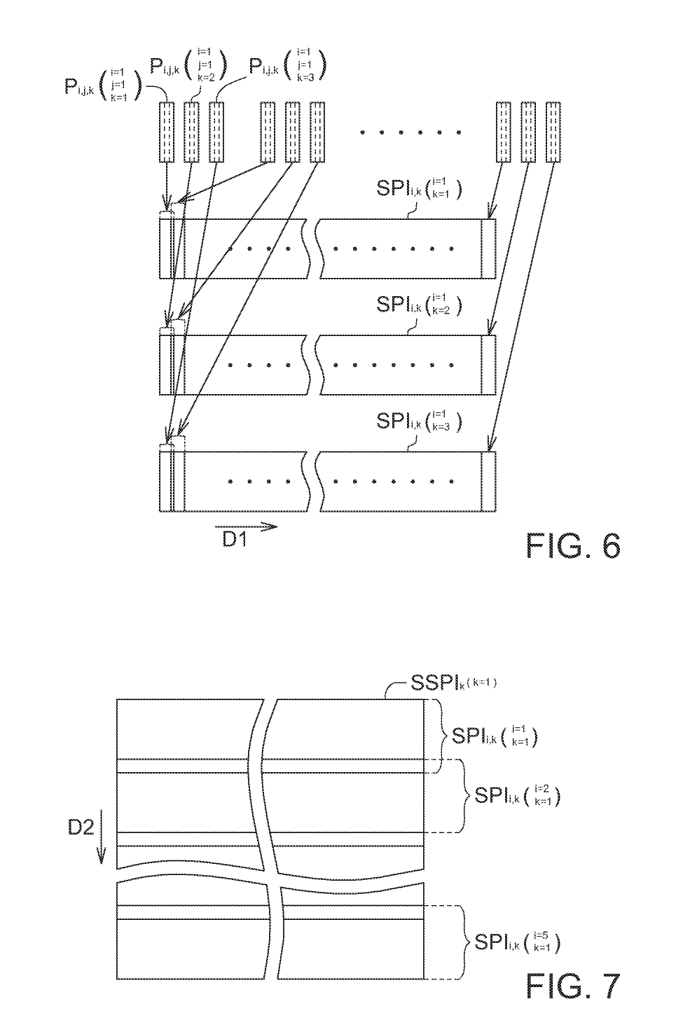

In the step S105, please refer to FIG. 6. FIG. 6 is a flow chart showing the step S105 in FIG. 2. The first connecting unit 140 connects part of the pixel blocks P_{i,j,k} (i=1 to 5, j=1 to 13, k=1 to 3), such as P_{i,j,k} (i=1, k=1), which are corresponding to one of the moving paths Rᵢ (i=1 to 5), such as Rᵢ (i=1), and corresponding to one of the view angles VAₖ (k=1 to 3), such as VAₖ (k=1), along a first connecting direction D1 to result in a single-view panoramic image SPI_{i,k} (i=1 to 5, k=1 to 3), such as SPI_{i,k} (i=1, k=1).

Similarly, the first connecting unit 140 can connect another part of the pixel blocks P_{i,j,k} (i=1 to 5, j=1 to 13, k=1 to 3), such as P_{i,j,k} (i=1, k=2), which are corresponding to another one of the view angles VAₖ (k=1 to 3), such as VAₖ (k=2), along the first connecting direction D1 to result in another single-view panoramic image SPI_{i,k} (i=1 to 5, k=1 to 3), such as SPI_{i,k} (i=1, k=2).

Similarly, the first connecting unit 140 can connect another part of the pixel blocks P_{i,j,k} (i=1 to 5, j=1 to 13, k=1 to 3), such as P_{i,j,k} (i=2, k=1), which are corresponding to another one of the moving paths Rᵢ (i=1 to 5), such as Rᵢ (i=2), along the first connecting direction D1 to result in another single-view panoramic image SPI_{i,k} (i=1 to 5, k=1 to 3), such as SPI_{i,k} (i=2, k=1).

For example, part of the pixel blocks P_{i,j,k} (i=1 to 5, j=1 to 13, k=1 to 3), which are corresponding to the same moving path Rᵢ (i=1 to 5) and corresponding to the same view angle VAₖ (k=1 to 3) will be connected and results in one single-view panoramic image SPI_{i,k} (i=1 to 5, k=1 to 3). In the present embodiment, number of the moving paths Rᵢ (i=1 to 5) is 5 and number of the view angles VAₖ (k=1 to 3) is 3, thus number of the single-view panoramic image SPI_{i,k} (i=1 to 5, k=1 to 3) is 15.

In step S107, please refer to FIG. 7. FIG. 7 is a flow chart showing the step S107 in FIG. 2. The second connecting unit 150 connects part of the single-view panoramic images SPI_{i,k} (i=1 to 5, k=1 to 3) which are corresponding to all of the moving paths Rᵢ (i=1 to 5) and corresponding to one of the view angles VAₖ (k=1 to 3), such as VAₖ (k=1), along a second connecting direction D2 to result in a super-resolution single-view panoramic image SSPIₖ (k=1 to 3), such as SSPIₖ (k=1). The second connecting direction D2 is substantially perpendicular to the first connecting direction D1.

Similarly, the second connecting unit 150 connects another part of the single-view panoramic images SPI_{i,k} (i=1 to 5, k=1 to 3) which are corresponding to another view angle VAₖ (k=1 to 3), such as VAₖ (k=1), along the second connecting direction D2 to result in another super-resolution single-view panoramic image SSPIₖ (k=1 to 3), such as SSPIₖ (k=2).

For example, please referring to FIG. 7, the 15 single-view panoramic images SPI_{i,k} (i=1 to 5 and k=1 to 3) are corresponding to 3 view angle VAₖ (k=1 to 3). Those single-view panoramic images SPI_{i,k} (i=1 to 5 and k=1 to 3) can be connected along the second connecting direction D2 and results in 3 super-resolution single-view panoramic images SSPIₖ (k=1 to 3).

In step S109, the parallax adjusting unit 160 adjusts the parallax of each super-resolution single-view panoramic image SSPIₖ (k=1 to 3) to be within the stereo fusion range of human eyes.

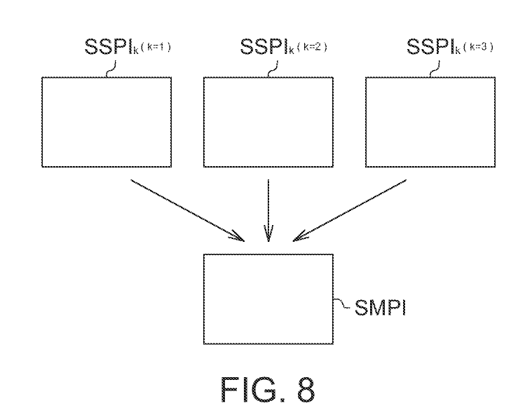

In step S111, please refer to FIG. 8. FIG. 8 is a flow chart showing the step S111 in FIG. 2. The interlacing unit 170 interlaces all of the super-resolution single-view panoramic images SSPIₖ (k=1 to 3) which are corresponding to all of the view angles VAₖ (k=1 to 3) to result in a super-resolution multi-view panoramic image SMPI.

In this step, parallax between two adjacent view angles VAₖ (k=1 to 3) substantially coincides with the stereo fusion restriction of human eyes. Therefore, after interlacing all of the super-resolution single-view panoramic images SSPIₖ (k=1 to 3), the super-resolution multi-view panoramic image SMPI will have stereoscopic vision.

As above, the original images I_{i,j} (i=1 to 5, j=1 to 13) captured along one of the moving paths Rᵢ (i=1 to 5) can be captured a plurality of pixel blocks P_{i,j,k} (i=1 to 5, j=1 to 13, k=1 to 3) corresponding to different view angles VAₖ (k=1 to 3). Therefore, the shooting unit 110 realized by a camera having a single lens set of the present embodiment can produce stereoscopic image. The number of the view angles VAₖ (k=1 to 3) does not have any relations with the number of the lens set, the number of the view angles VAₖ (k=1 to 3) can be realized by operating process.

Base on the above steps, the connection along the first connecting direction D1 makes an image having panoramic vision, and the connection along the second connecting direction D2 increases the resolution of an image.

Although the connection along the first connecting direction D1 is performed before the connection along the second connecting direction D2; however, the performing sequence can be overturned, such that the connection along the second connecting direction D2 can be performed before the connection along the first connecting direction D1.

### Second Embodiment

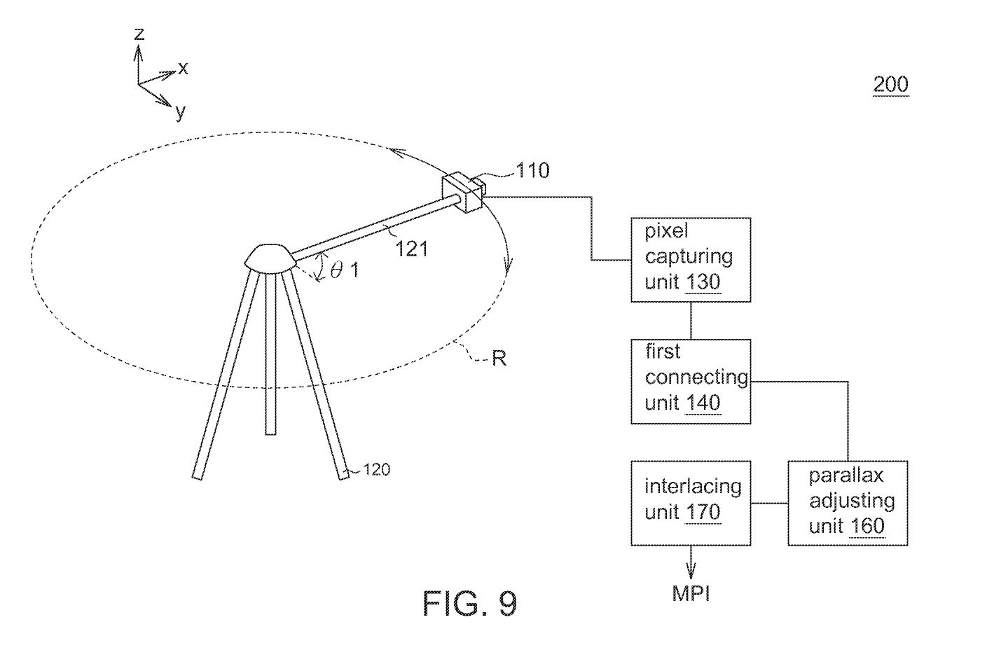

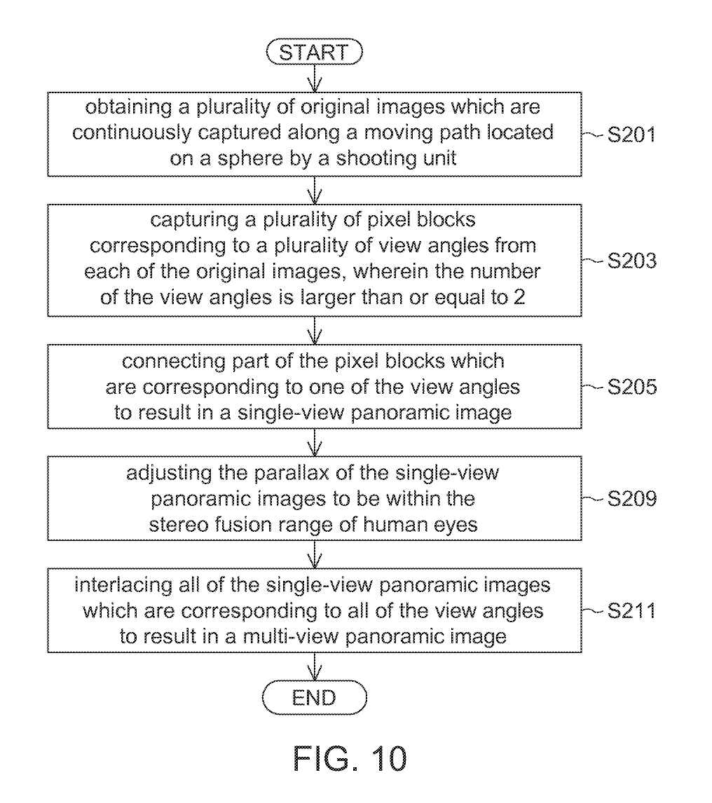

Please refer to FIGS. 9 and 10. FIG. 9 is a schematic illustration showing a system 200 for producing a panoramic image of a second embodiment. FIG. 10 is a flow chart showing a method for producing the panoramic image of the second embodiment. The difference between the present embodiment and the first embodiment is that the system 200 of the present embodiment does not include the second connecting unit 150 and the method of the present embodiment does not include the step S107. Other similarities are not repeated here.

In the present embodiment, the steps S201, S203, S205, S209 and S211 are similar to the step S101, S103, S105, S109 and S111. In the step S201, S203, S205, S209 and S211 of the present embodiment, the shooting unit 110 only moves along one moving path R, and only the original images corresponding to the moving path R are processed. In the procedure, the method does not perform vertical connection, and a multi-view panoramic image MPI is resulted at the end of the method.

### Third Embodiment

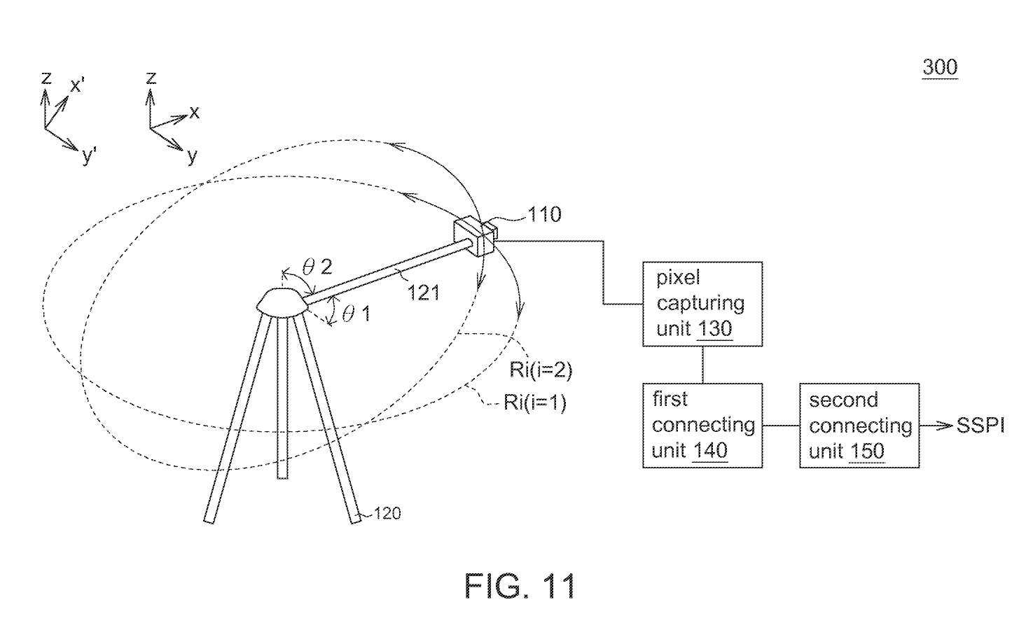

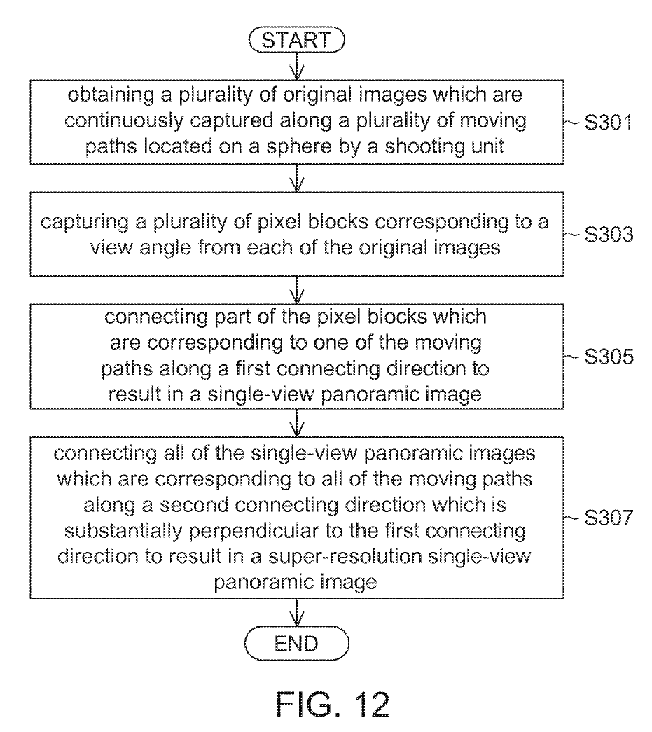

Please refer to FIGS. 11 and 12. FIG. 11 is a schematic illustration showing a system 300 for producing a panoramic image of a third embodiment. FIG. 12 is a flow chart showing a method for producing the panoramic image of the third embodiment. The difference between the present embodiment and the first embodiment is that the system 300 of the present embodiment does not include the parallax adjusting unit 160 and the interlacing unit 170, and the method of the present embodiment does not include the step S109 and the step S111. Other similarities are not repeated here.

The steps S301, S303, S305 and S307 are similar to the steps of S101, S103, S105 and S107. In the steps S301, S303, S305 and S307 of present embodiment, the pixel capturing unit 130 captures the pixel blocks corresponding to only one view angle. In the method, the pixel blocks corresponding to only one view angle are processed. The method does not have any step of parallax adjusting and any step of interlacing, and a super-resolution signal-view panoramic image SSPI is resulted at the end of the method.

While the disclosure has been described by way of examples and in terms of disclosed embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for producing a panoramic image, comprising:
obtaining a plurality of original images;
capturing a plurality of pixel blocks corresponding to a plurality of view angles from each of the original images, wherein the number of the view angles is larger than or equal to 2; and
connecting part of the pixel blocks which are corresponding to one of the view angles along a connecting direction to result in a single-view panoramic image, wherein the step of connecting part of the pixel blocks are performed repeatedly to result in a plurality of single-view panoramic images.

2. The method according to claim 1, wherein the original images are continuously captured along only one moving path located on a sphere by a shooting unit.

3. The method according to claim 2, further comprising:
interlacing all of the single-view panoramic images which are corresponding to all of the view angles to result in a multi-view panoramic image.

4. The method according to claim 3, wherein before the step of interlacing all of the single-view panoramic images, the method further comprises:
adjusting the parallax of the single-view panoramic images to be within the stereo fusion range of human eyes.

5. The method according to claim 3, wherein in the step of obtaining the original images, distances between every two adjacent locations are substantially equal.

6. The method according to claim 3, wherein in the step of capturing the pixel blocks, each of the pixel blocks includes a plurality columns of pixels.

7. The method according to claim 3, wherein in the step of capturing the pixel blocks, each parallax of every two adjacent view angles substantially coincides with the stereo fusion restriction of human eyes.

8. The method according to claim 1, wherein the original images are continuously captured along a plurality of moving paths located on a sphere by a shooting unit.

9. The method according to claim 8, further comprising:
connecting part of the single-view panoramic images which are corresponding to all of the moving paths and corresponding to one of the view angles along another connecting direction to result in a super-resolution single-view panoramic image, wherein the step of connecting part of the single-view panoramic images is performed repeatedly to result in a plurality of super-resolution single-view panoramic images; and
interlacing all of the super-resolution single-view panoramic images which are corresponding to all of the view angles to result in a super-resolution multi-view panoramic image.

10. The method according to claim 9, wherein before the step of interlacing all of the super-resolution single-view panoramic images, the method further comprises:
adjusting the parallax of the super-resolution single-view panoramic images to be within the stereo fusion range of human eyes.

11. The method according to claim 8, wherein in the step of obtaining the original images, distances between every two adjacent locations where two adjacent original images are captured along the same path are substantially equal.

12. The method according to claim 8, wherein in the step of capturing the pixel blocks, each of the pixel blocks includes a plurality columns of pixels.

13. The method according to claim 8, wherein in the step of capturing the pixel blocks, each parallax of every two adjacent view angles substantially coincides with the stereo fusion restriction of human eyes.

14. A method for producing a panoramic image, comprising:
obtaining a plurality of original images which are continuously captured along a plurality of moving paths located on a sphere by a shooting unit;
capturing a plurality of pixel blocks corresponding to a view angle from each of the original images;
connecting part of the pixel blocks which are corresponding to one of the moving paths along a first connecting direction to result in a single-view panoramic image, wherein the step of connecting part of the pixel blocks are performed repeatedly to result in a plurality of single-view panoramic images;
connecting all of the single-view panoramic images which are corresponding to all of the moving paths along a second connecting direction which is substantially perpendicular to the first connecting direction to result in a super-resolution single-view panoramic image.

15. A system for producing a panoramic image, comprising:
a shooting unit;
a multi-axles stand, for moving the shooting unit along a plurality of moving paths located on a sphere, wherein the shooting unit continuously captures a plurality of original images while the shooting unit are moving;
a pixel capturing unit, for capturing a plurality of pixel blocks corresponding to a plurality of view angles from each of the original images, wherein the number of the view angles is larger than or equal to 2;
a first connecting unit, for connecting part of the pixel blocks which are corresponding to one of the moving paths and corresponding to one of the view angles along a first connecting direction to result in a single-view panoramic image, wherein the first connecting unit repeatedly connects part of the pixel blocks to result in a plurality of single-view panoramic images;
a second connecting unit, for connecting part of the single-view panoramic images which are corresponding to all of the moving paths and corresponding to one of the view angles along a second connecting direction which is substantially perpendicular to the first connecting direction to result in a super-resolution single-view panoramic image, wherein the second connecting unit repeatedly connects part of the single-view panoramic images to result in a plurality of super-resolution single-view panoramic images; and
an interlacing unit, for interlacing all of the super-resolution single-view panoramic images which are corresponding to all of the view angles to result in a super-resolution multi-view panoramic image.

16. The system according to claim 15, further comprising:
a parallax adjusting unit, for adjusting the parallax of the super-resolution single-view panoramic images to be within the stereo fusion range of human eyes.
